(19) United States
(12) Patent Application Publication
(10) Pub. No.: US 2006/0205345 A1
(43) Pub. Date: Sep. 14, 2006

(54) Air radio system

(75) Inventor: Kazunori Ishikawa, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/359,425

(22) Filed: Feb. 23, 2006

(30) Foreign Application Priority Data
Feb. 25, 2005 (JP) 2005-049853

(51) Int. Cl. H04B 7/185

(52) U.S. Cl. 455/12.1

(57) ABSTRACT

In an air radio system for performing voice communications among a first aircraft provided with an analog radio, a second aircraft provided with a digital radio, and a ground station, the ground station includes a first communication station for performing radio communications of an analog voice with the first aircraft, a second communication station for performing radio communications of a digital voice with the second aircraft, and a control apparatus for converting the downlink analog voice or the downlink digital voice received by the first or second communication station into voice data, and supplying the voice data to be transmitted to aircrafts to the first and second communication stations, respectively. A voice from an air controller in the air control section is radio-transmitted as an uplink analog voice and an uplink digital voice simultaneously from the first and second communication stations via the control apparatus.

### BACKGROUND OF THE INVENTION

1. Field of the Invention

The present invention relates to an air radio system, and more particularly relates to an air radio system applicable to a case where aircrafts flying in the same air area perform control communications by radio communication systems which are different one another.

2. Description of the Related Art

An air radio system is a system for performing radio communications between an aircraft station and a ground station and among a plurality of aircraft stations in aircrafts. The aircraft station is a communication station arranged in an aircraft. Also, the ground station is a communication station provided on the ground so as to perform radio communications with the aircraft. In the air radio system, the ground station mediates communications between an air control desk (or air control room, air traffic control tower) provided on the ground for air control and the aircraft station.

In the conventional air radio system, the aircraft station and the ground station employ analog radios for the UHF band or the VHF band and transmits/receives voice signals modulated in the DSB-AM modulation scheme so as to perform voice radio communications. Each aircraft flying in the same sector (i.e., cover area) uses the air radio system to receive each voice signal and to share control information. Also, a pilot in the aircraft listens to an available channel in voice channels, and executes voice transmission from the aircraft with timing in which the voice channel is not used. In such a conventional air radio system, digitization is considered in order to resolve a channel shortage which is expected in the future, to satisfy security such as a phantom controller, and to extend additional functions for safety operations.

Now, in the conventional air radio system, the analog radio in the aircraft station for the civilian aircraft employs the VHF band, and the analog radio in the aircraft station for the military aircraft employs the UHF band. In order to support air control operations in the same sector (i.e., cover area), a voice from an air controller in the ground station is transmitted simultaneously by signals of the VHF band and the UHF band.

However, for the ground station, in order to resolve a channel shortage which is expected in the future, to satisfy security such as a phantom controller, and to extend additional functions for safety operations, in a case of introducing a new system incompatible with the existing air radio system, radios in aircrafts, namely, in aircraft stations cannot be changed into radios compatible with the new system at the same time. Therefore, it is absolutely necessary to operate the existing air radio system and the new air radio system in parallel. As a result, in the extension of the existing air radio system, communications can be performed only among the ground stations using the same air radio system, and voice information cannot be shared among aircrafts to which a different air radio system is introduced.

Now, in the field of the mobile communication system on the ground, for example, as shown in Japanese Patent Laid-open No. 2004-080431 (JP, 2001-080431A), there is known a communication control system capable of processing calls among subscriber terminals belonging to different communication networks when a plurality of communication networks adopting various communication systems exists. The communication control system is provided with a common subscriber database and a common service control apparatus for the plurality of communication networks adopting various communication systems. In the subscriber database, information related to each subscriber terminal used in each communication network, namely, subscriber information is stored. The service apparatus connects with each subscriber terminal using each communication network and performs call processing while referring to the subscriber database. According to such a communication control system, call processing among subscriber terminals belonging to the plurality of networks in various communication systems can be performed by employing the common subscriber database and the common service apparatus.

Therefore, by applying the communication control system to the above-mentioned plurality of air radio systems of different types, it is suggested that the voice information is shared among aircrafts employing various air radio systems. Hoverer, the above-mentioned communication control system is predicated on the application to the mobile communication system performing one-to-one communication between subscriber terminals, and cannot be applied to the air radio system in which the voice information is shared by performing one-to-plurality communications among the plurality of aircrafts through the mediation of the air controller (or ground station) via the half-duplex communications between the air controller (i.e., ground station) and the aircraft (i.e., aircraft station).

Consequently, when the plurality of air radio systems of different types coexist, there are tendencies in that transmissions from the plurality of aircrafts employing the air radio systems of different types are overlapped and in that the pilot makes retransmission because of no response. These tendencies cause a high possibility that the safety, the efficiency, and the like in the control operations are hindered.

### SUMMARY OF THE INVENTION

Accordingly, it is an object of the present invention to provide an air radio system, even if a plurality of air radio systems of different types coexist, capable of being operated while the plurality of air radio systems are operated just like a single air radio system, capable of improving the efficiency and the safety of the control operations, and capable of performing aircraft-to-aircraft communication, namely, air-to-air communications.

The object of the present invention is attained by an air radio system, when a first aircraft provided with an analog radio as an aircraft station and a second aircraft provided with a digital radio as an aircraft station exist in a same control cover area, for performing voice communications among the first and second aircrafts and a ground station; wherein the ground station includes: a first communication station for performing radio communications of an analog voice with the analog radio in the first aircraft; a second communication station for performing radio communications of a digital voice with the digital radio in the second aircraft; and a control apparatus for converting a downlink analog voice or a downlink digital voice received by the first or second communication station into voice data, delivering the converted voice data to an air control section, and supplying voice data received from the air control section to the first and second communication stations, respectively: and wherein a voice from the air control section is radio-transmitted as an uplink analog voice and an uplink digital voice simultaneously from the first and second communication stations, respectively, via the control apparatus.

With this arrangement, radio communications between the first and second aircrafts employing the different radio systems and the air control section (or the air traffic control tower) can be operated just like the same radio system is used, and thus no hindrance is made to control operation efficiency.

In the present invention, preferably, the control apparatus converts the downlink voice received by one of the first and second communication stations into voice data so as be transmitted to the air control section and transmits the voice data to the other of the first and second communication stations as an uplink voice. In other words, preferably, in the air radio system, a corresponding ground system transmits the reception voice from ground station as voice data to another ground system of a different type, and the voice data is retransmitted from the ground system.

With this arrangement, it is possible for an aircraft for transmitting no voice in the first and second aircrafts to receive the voice communicated between the aircraft for transmitting the voice and the air control section. Further, communications between the first and second aircrafts are possible.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a view showing a configuration of an air radio system according to the first embodiment of the present invention;

FIG. 2 is a view for explaining an operation when downlink voices are received simultaneously; and

FIG. 3 is a view for explaining an operation when downlink voices are received simultaneously in an air radio system according to the second embodiment of the present invention.

### DESCRIPTION OF THE PREFERRED EMBODIMENTS

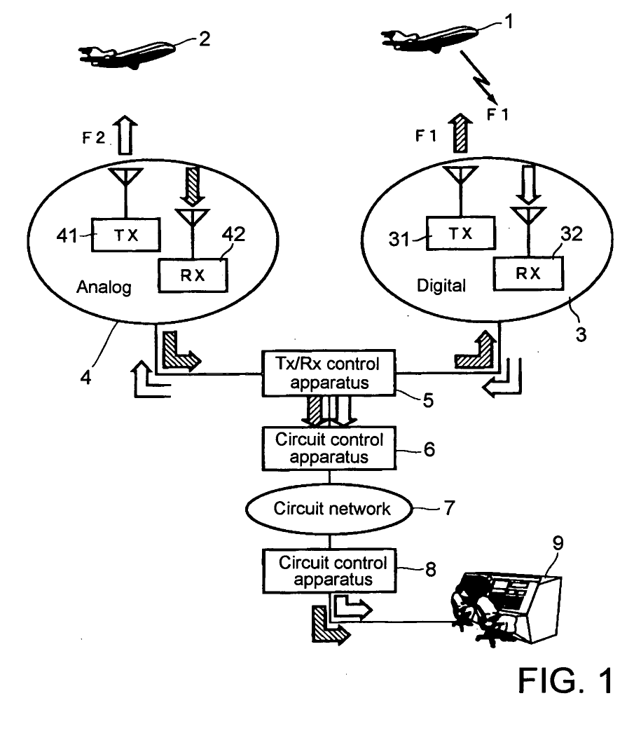

An air radio system according to the first embodiment of the present invention shown in FIG. 1 is provided with: an aircraft station installed on first aircraft 1 and including a digital radio; an aircraft station installed on second aircraft 2 and including an analog radio; a remote site arranged on the ground; circuit network 7; air control desk 9 operated by an air controller; circuit control apparatus 6 connecting the remote site and circuit network 7; and circuit control apparatus 8 connecting circuit network 7 and air control desk 9. The remote site is provided with digital communication station 3, analog communication station 4, and transmission/reception (Tx/Rx) control apparatus 5. Transmission/reception control apparatus 5 connects with both digital communication station 3 and analog communication station 4 and connects with circuit network 7 via circuit control apparatus 6.

Digital communication station 3 includes transmitter (TX) 31 and receiver (RX) 32 respectively provided with antennas. Similarly, analog communication station 4 includes transmitter (TX) 41 and receiver (RX) 42 respectively provided with antennas. Plural groups of digital communication station 3, analog communication station 4, and transmission/reception control apparatus 5 may be provided for backup.

The aircraft station on second aircraft 2 is an analog radio similar to that in the conventional air radio system. The aircraft station on second aircraft 2 uses the VHF band when aircraft 2 is a civilian aircraft and uses the UHF band when a military aircraft. Since voices from the ground station are transmitted by simultaneous transmission of analog voice signals in the UHF band and in the VHF band, the aircraft station on aircraft 2 may use the UHF band or the VHF band for reception of the voices from the ground station.

On the other hand, the aircraft station on first aircraft 1 is provided with a digital radio. This digital radio is provided with a receiver compliant with international standards such as VDL Mode 3 and transmits and receives signals in the VHF band.

Next, the operation of the air radio system according to the first embodiment is explained while being divided into uplink voice transmission, downlink voice transmission, and the like.

(1) Uplink Voice Transmission:

Uplink voice information to be transmitted from air control desk 9 to first and second aircrafts 1, 2 is relayed from air control desk 9 to circuit control apparatus 8, and further, via circuit network 7, circuit control apparatus 6, and transmission/reception control apparatus 5, is supplied to digital communication station 3 and analog communication station 4. Transmission paths for the voice information from air control desk 9 to respective communication stations 3, 4 are those employing interfaces commonly set for the plurality of different systems, and the voice information is digital voice information and may be analog voice information. This arrangement makes merits that the existing air radio system is not required to be modified and that there is no influence by the interfaces in the new system.

Uplink voice information is transmitted to transmitter 31 in digital communication station 3 and transmitter 41 in analog communication station 4, and is radio-transmitted (radio wave launched) from transmitter 31 and transmitter 41 simultaneously. Because of the simultaneous transmission, the respective transmission frequencies in the VHF band and the UHF band in transmitter 31 and a transmission frequency in the VHF band in transmitter 41 are different one another and are required to have sufficient frequency differences to prevent intermodulation. Both launched radio waves are received by the analog radio in aircraft 1 and the digital radio in aircraft 2 in the same sector (cover area). Accordingly, first aircraft 1 and second aircraft 2 obtain the same voice information from air control desk 9.

(2) Downlink Voice (Digital Voice) Transmission:

The aircraft station on aircraft 1 entering a control cover area starts downlink digital voice transmission in order to obtain permission for flight. As described above, aircraft 1 is provided with the digital radio as the aircraft station, and the transmission frequency thereof is tuned to the reception frequency of the digital communication station 3. Transmission radio waves from the aircraft station on aircraft 1 are received by receiver 31 of digital communication station 3 in the remote site. Received voice signals are transmitted to transmission/reception control apparatus 5 and are converted into voice data similarly to the uplink voices.

Reception voice data converted by transmission/reception control apparatus 5 is respectively supplied to circuit control apparatus 6 and analog communication station 4. The reception voice data supplied to circuit control apparatus 6 is supplied to air control desk 9 through circuit network 7 via circuit control apparatus 8 in the air control section. With this operation, at air control desk 9, the air controller can listen to the voices from the aircraft station on aircraft 1. On the other hand, the reception voice data supplied to analog communication station 4 is radio-launched as analog voice transmission in the same way as the uplink voice without being conscious of the voices from the aircraft station on aircraft 1 and is received by the analog radio on aircraft 2. As a result, also in aircraft 2, the downlink voice from aircraft 1 can be listened to.

(3) Downlink Voice (Analog Voice) Transmission:

When the aircraft station on aircraft 2 entering the control cover area starts voice transmission, the voice information is received by receiver 42 of analog communication station 4 in the remote site as downlink analog transmission radio waves and is supplied to transmission/reception control apparatus 5. Received voice signals are converted into reception voice data in transmission/reception control apparatus 5 so as to be supplied to digital communication station 3 and circuit control apparatus 6. The reception voice data supplied to circuit control apparatus 6 is supplied to air control desk 9 through circuit network 7 via circuit control apparatus 8 in the air control section. With this operation, the air controller who operating air control desk 9 can listen to voices from the pilot on aircraft 2. On the other hand, the reception voice data supplied to digital communication station 3 is radio-launched as digital voice transmission in the same way as the uplink voice without being conscious of the voice from the aircraft station on aircraft 2 and is received by the digital radio on aircraft 1. As a result, also in aircraft 1, the downlink voice from aircraft 2 can be listened to.

(4) Simultaneous Downlink Reception:

For voice transmission from aircrafts 1, 2, the pilot who is listening to the voice channel determines whether voice transmission is performed or not in the voice channel, and then the voice transmission from aircrafts 1, 2 is started in the voice channel determined to be not in use. As described above, the voice information is shared among the different systems, and the repetition in which the voice transmission from aircraft 1 and the voice transmission from aircraft 2 are performed simultaneously is reduced, but is not completely eliminated. In accordance with timing or the like, there is a possibility that voice information is transmitted simultaneously from aircraft 1 and aircraft 2 in the downlink.

When the simultaneous transmission occurs in the downlink of the same radio system, in accordance with the degree of interference, neither voice information can be listened to and recognized, or only the voice information of which the radio wave is stronger can be received. On the other hand, when the simultaneous transmission occurs among different radio systems like the first embodiment, the channels separated as radio resources are used, and therefore both voice information can be received properly. However, when the voice information received in this way is listened by the air controller as it is, the voice information from both the aircrafts is overlapped. Therefore, it is difficult for the air controller to grasp contents of the voice information, and therefore, there is a possibility that the control operation is hindered.

For this reason, preferably, in the air radio system according to the first embodiment, transmission/reception control apparatus 5 estimates signal qualities such as timing and reception strengths when respective voice signals are received by digital communication station 3 and analog communication station 4, selects the voice data from only one of digital communication station 3 and analog communication station 4 according to the results of the estimation, and transmits the selected voice data to circuit control apparatus 6 and the not-selected communication station in the system. Since radio channels and receivers are isolated among the different radio systems, there is no influence by so-called interference, and only the voice having priority can be received by transmission/reception control apparatus 5 and can be supplied to air control desk 9. In other words, when voice information is simultaneously received among the different radio systems, the air controller can listen to the downlink voice from an aircraft belonging to one system. Transmission/reception control apparatus 5 determines the voice information to be given high priority in accordance with a reception level or reception timing. When the voice information to be given high priority is determined in accordance with the reception timing, for example, the priority is given to the voice information in which reception is started earlier, namely, first-come-first-served based method may be used.

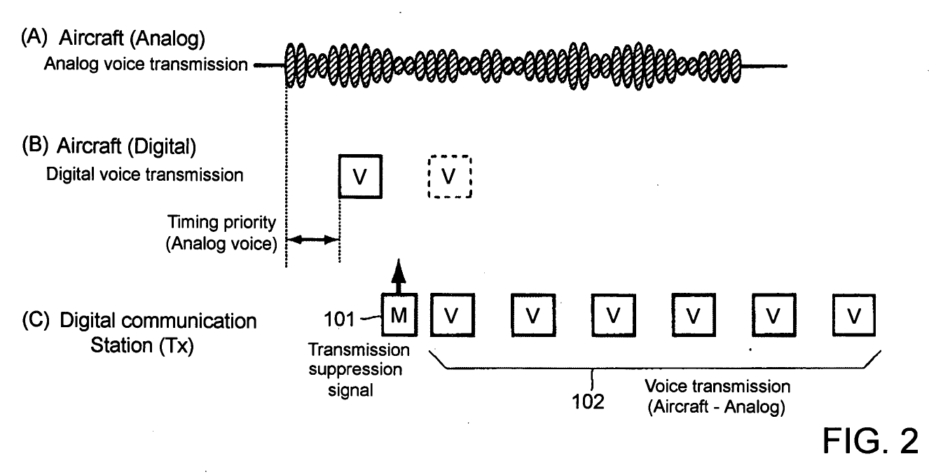

Referring to FIG. 2, detailed explanations are given of the priority control like this.

Transmission/reception control apparatus 5, when priority is given to the analog voice from aircraft 2 having the aircraft station of the analog type, as indicated by (A) in FIG. 2, transmits only the analog voice from aircraft 2 to air control desk 9 and takes measures instructing aircraft 1 transmitting the digital voice to stop voice transmission immediately. In a digital air radio system, VDL Mode 3 is defined as an international standard and means for eliminating interference troubles called an anti-blocking function is incorporated. With this function, transmission/reception control apparatus 5 transmits signal M 101 suppressing voice transmission to aircraft 1 via digital communication station 3 and analog voice signal V having priority is retransmitted via digital communication station 3 so as to be transmitted to aircraft 1.

With this operation, the digital radio on aircraft 1, for transmitting digital signal V with timing indicated by (B) in FIG. 2 receives transmission suppression signal M 101 indicated by (C) in FIG. 2 from digital communication station 3 so as to suppress transmission. Successively, since the analog voice having priority is transmitted from digital communication station 3 to aircraft 1 in the form of digital signals indicated by reference numeral 102 of (C) in FIG. 2, the digital radio on aircraft 1 receives them. By executing the procedure like this, the pilot of aircraft 1 provided with the digital radio listens to voices different from the voice transmitted from the pilot himself or herself, and therefore, with audible sounds, the pilot can recognize that the voice transmission is not permitted.

Transmission/reception control apparatus 5, when priority is given to digital voices, transmits only digital voices from aircraft 1 to air control desk 9 and does not perform retransmission in the uplink from analog communication station 4 to aircraft 2 transmitting analog voices. As its reasons, only radio wave interferences occur even if transmission is performed mutually, and the analog radio on the aircraft cannot be stopped. Transmission of only the voice data of the received digital voice to air control desk 9 allows the air controller to hear clear voices.

(5) Communications Among Aircrafts:

In the air radio system according to the first embodiment, with the same procedure as the downlink voice in above-mentioned (2) and (3), communications can be performed among the plurality of aircrafts using different radio systems via the ground station (i.e., remote site). In other words, the digital transmission radio wave in the downlink launched from the digital radio on aircraft 1 is received by digital communication station 3, is converted into voice data in transmission/reception control apparatus 5, and is further converted into an analog radio wave of a predetermined frequency in analog communication station 4 so as to be transmitted to aircraft 2. On the other hand, the analog transmission radio wave in the downlink launched from the analog radio on aircraft 2 is received by analog communication station 4, is converted into voice data in transmission/reception control apparatus 5, and is converted into a digital radio wave in digital communication station 3 so as to be transmitted to aircraft 1. In this way, communications can be performed between aircraft 1 and aircraft 2, and the contents of the communication thereof are also received by air control desk 9. According to the first embodiment, by performing interface conversion in the ground station communication system, it becomes possible to perform communications between aircraft 1 and aircraft 2 employing the radio systems which are mutually different.

Further, in the air radio system according to the first embodiment, it is possible to listen to voices of the pilots on the all aircrafts existing in the control cover area and the air controller. With this arrangement, the pilot can recognize available voice channels and select suitable transmission timing. Accordingly, by applying the air radio system according to the first embodiment, even if a new radio system is introduced in parallel with the existing radio system, there is no case that the control operations are hindered. Further, when the new radio system is introduced, the infrastructure which has been already provided between transmission/reception control apparatus 5 and air control desk 9 can be shared. Therefore, it becomes easier to introduce the new radio system by applying the first embodiment.

Next, an air radio system according to the second embodiment of the present invention is explained. The principal configuration of this air radio system is similar to that of the first embodiment shown in FIG. 1, however, further refinements are made to the process when reception is performed simultaneously among different radio systems. In the air radio system according to the first embodiment, when a downlink analog voice and a downlink digital voice are received simultaneously, transmission/reception control apparatus 5 selects one of the analog voice and the digital voice, however, in the second embodiment, a voice level is adjusted in accordance with timing or a reception level, and both the analog voice and the digital voice are output simultaneously.

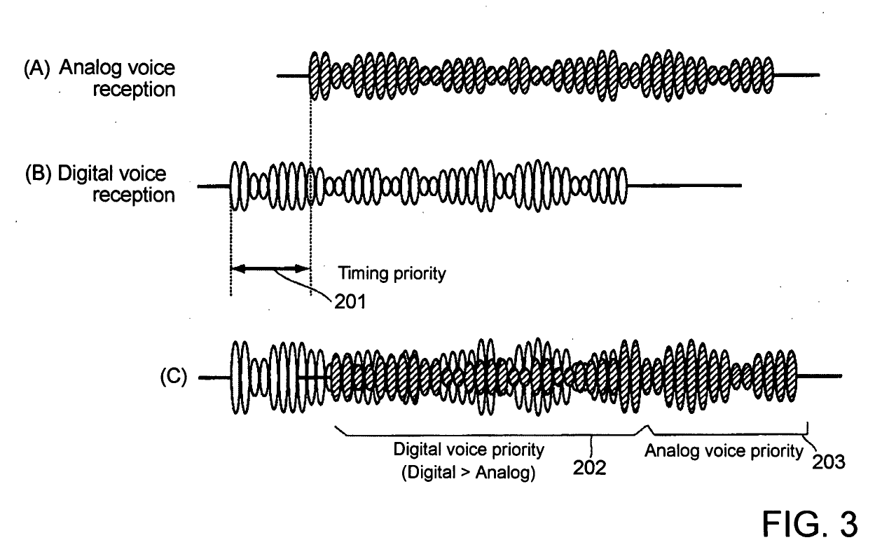

Hereinafter, explanations are given of the operation when downlink voices are received simultaneously in the air radio system according to the second embodiment with reference to FIG. 3. In FIG. 3, (A) represents an analog voice in the downlink and (B) represents a digital voice in the downlink. As indicated by reference numeral 201 in FIG. 3, when reception starting timing of the digital voice in the downlink is earlier than reception starting timing of the analog voice in the downlink, transmission/reception control apparatus 5 superimposes both the voices and transmits them to air control desk 9, as indicated by (C) in FIG. 3.

However, since the digital voice is given high priority, during a superimposing period indicated by reference numeral 202 in FIG. 3, the sound level of the analog voice which starts transmission later is reduced to be superimposed on the digital voice, and the air controller can operate the digital voice with priority. Also, he or she can confirm that the analog voice and the digital voice are received simultaneously.

When reception of the digital voice is finished, only the analog voice signal is transmitted as indicated by reference numeral 203 in FIG. 3. At the time of finishing reception of the digital voice, the sound level of the analog voice is returned to the original level. With this operation, the transmission source of the analog voice can be recognized, and the air controller can request for retransmission of the analog voice information of which contents are hard to be recognized because the digital voice is superimposed with priority.

Incidentally, in FIG. 1, explanations are given of the case in that aircraft 1 provided with the digital radio as the aircraft station and aircraft 2 provided with the analog radio as the aircraft station exist one by one in the same cover area (sector), however, the present invention is also available to a case in that a plurality of aircrafts provided with digital radios and a plurality of aircrafts provided with analog radios exist.

While preferred embodiments of the present invention have been described using specific terms, such description is for illustrative purposes only, and it is to be understood that changes and variations may be made without departing from the spirit or scope of the following claims.

What is claimed is:

1. An air radio system, when a first aircraft provided with an analog radio as an aircraft station and a second aircraft provided with a digital radio as an aircraft station exist in a same control cover area, for performing voice communications among the first and second aircrafts and a ground station;
wherein the ground station comprising:
a first communication station for performing radio communications of an analog voice with the analog radio in the first aircraft;
a second communication station for performing radio communications of a digital voice with the digital radio in the second aircraft; and
a control apparatus for converting a downlink analog voice or a downlink digital voice received by the first or second communication station into voice data, delivering converted voice data to an air control section, and supplying voice data received from the air control section to the first and second communication stations, respectively: and
wherein a voice from the air control section is radio-transmitted as an uplink analog voice and an uplink digital voice simultaneously from the first and second communication stations, respectively, via the control apparatus.

2. The system according to claim 1, wherein the control apparatus converts a downlink voice received by one of the first and second communication stations into voice data so as be transmitted to the air control section and transmits the voice data to the other of the first and second communication stations as an uplink voice.

3. The system according to claim 1, wherein, when the first and second communication stations respectively receive a downlink analog voice and a downlink digital voice simultaneously, the control apparatus selects only a downlink voice received by one of the first and second communication stations and converts the downlink voice into the voice data so as to be transmitted to the air control section.

4. The system according to claim 3, wherein the control apparatus selects the downlink voice in accordance with voice reception timing in the first and second communication stations or reception signal qualities in the first and second communication stations.

5. The system according to claim 3, wherein, when the first and second communication stations respectively receive the downlink analog voice and the downlink digital voice simultaneously and when only the downlink analog voice received by the first communication station is selected, the control apparatus, after transmitting a transmission suppression signal from the second communication station to the second aircraft, converts the downlink analog voice received by the first communication station into the voice data, transmits the voice data from the second communication station to the second aircraft as the uplink digital signal, and transmits the voice data to the air control section.

6. The system according to claim 3, wherein, when the first and second communication stations respectively receive the downlink analog voice and the downlink digital voice simultaneously and when only the downlink digital voice received by the second communication station is selected, the control apparatus converts the downlink digital voice received by the second communication station into the voice data and transmits the voice data only to the air control section.

7. The system according to claim 1, wherein, after only the second communication station receives the downlink digital voice, when the first and second communication stations respectively receive the downlink analog voice and the downlink digital voice simultaneously, control apparatus, during a simultaneous reception period of the analog voice and the digital voice, generates a superimposed signal by lowering a sound level of the voice data of the analog voice than a sound level of the voice data of the digital voice and superimposing the analog voice on the digital voice, and transmits the superimposed signal to the air control section.

8. The system according to claim 2, wherein, when the first and second communication stations respectively receive a downlink analog voice and a downlink digital voice simultaneously, the control apparatus selects only a downlink voice received by one of the first and second communication stations and converts the downlink voice into the voice data so as to be transmitted to the air control section.

9. The system according to claim 8, wherein the control apparatus selects the downlink voice in accordance with voice reception timing in the first and second communication stations or reception signal qualities in the first and second communication stations.

10. The system according to claim 8, wherein, when the first and second communication stations respectively receive the downlink analog voice and the downlink digital voice simultaneously and when only the downlink analog voice received by the first communication station is selected, the control apparatus, after transmitting a transmission suppression signal from the second communication station to the second aircraft, converts the downlink analog voice received by the first communication station into the voice data, transmits the voice data from the second communication station to the second aircraft as the uplink digital signal, and transmits the voice data to the air control section.

11. The system according to claim 8, wherein, when the first and second communication stations respectively receive the downlink analog voice and the downlink digital voice simultaneously and when only the downlink digital voice received by the second communication station is selected, the control apparatus converts the downlink digital voice received by the second communication station into the voice data and transmits the voice data only to the air control section.

12. The system according to claim 2, wherein, after only the second communication station receives the downlink digital voice, when the first and second communication stations respectively receive the downlink analog voice and the downlink digital voice simultaneously, control apparatus, during a simultaneous reception period of the analog voice and the digital voice, generates a superimposed signal by lowering a sound level of the voice data of the analog voice than a sound level of the voice data of the digital voice and superimposing the analog voice on the digital voice, and transmits the superimposed signal to the air control section.
